(19) United States
(12) Patent Application Publication
(10) Pub. No.: US 2026/0368726 A1
(43) Pub. Date: Nov. 19, 2026

(54) MULTI-PARTICIPANT DISTRIBUTED TRANSACTION OPTIMIZATION WITH BLOCKCHAIN

(71) Applicant: International Business Machines Corporation, Armonk, NY (US)

(72) Inventors: Muhammad Shoaib Iqbal, Chesterbrook, PA (US); Joseph Kozhaya, Morrisville, NC (US); Chan Naseeb, Munich (DE)

(21) Appl. No.: 19/207,587

(22) Filed: May 14, 2025

(51) Int. Cl. G06Q 20/40; G06Q 20/38

(52) U.S. Cl. CPC G06Q 20/401; G06Q 20/382

(57) ABSTRACT

A shared blockchain network includes a primary entity for completing an end-to-end transaction, and a plurality of supporting entities that perform a local task set which supports the primary entity to complete the transaction. The shared blockchain network further includes a blockchain ledger controller that generates a blockchain ledger accessible by the primary entity and the plurality of supporting entities. The blockchain ledger controller receives a plurality of external metrics from the primary entity and the plurality of the supporting entities, and records the external metrics to blockchain ledger. The primary entity and the plurality of supporting entities utilize the blockchain ledger perform at least one local task so as to complete the local task set.

### BACKGROUND

The disclosure relates to computer systems, specifically to methods and systems for performing a multi-participant distributed transaction optimization with blockchain.

As enterprises engage in business, an end-to-end transaction typically involves multiple organizations that participate to deliver the service. Traditionally, each individual organization has visibility over the processes strictly owned and managed by the individual organization. Lack of visibility of the end-to-end transaction processes limits the ability of the different participants in optimizing their processes.

### SUMMARY

According to a non-limiting embodiment, shared blockchain network includes a primary entity for completing an end-to-end transaction, and a plurality of supporting entities that perform a local task set which supports the primary entity to complete the transaction. The shared blockchain network further includes a blockchain ledger controller that generates a blockchain ledger accessible by the primary entity and the plurality of supporting entities. The blockchain ledger controller receives a plurality of external metrics from the primary entity and the plurality of the supporting entities, and records the external metrics to blockchain ledger. The primary entity and the plurality of supporting entities utilize the blockchain ledger perform at least one local task so as to complete the local task set.

According to another non-limiting embodiment, a computer-implemented method is provided for performing a multi-participant distributed transaction optimization using a shared blockchain network. The method comprises generating, by a shared blockchain network, a blockchain ledger accessible by a plurality of entities participating in the shared blockchain network. The plurality of entities including a primary entity configured to complete a transaction, and one or more supporting entities configured to support the primary entity to complete the transaction. The method further includes identifying, by each of the entities, a local task set including at least one local task for which a given entity among the plurality of entities is responsible in order to provide the support. The method further includes determining, by each of the entities, at least one external metric that impacts a performance of the local task set, and determining an organization responsible for providing the at least one external metric. The method further includes reporting, by each of the entities, the at least one external metric and the organization on a blockchain ledger of the shared blockchain network, and continuously reporting on the blockchain ledger, by each of the entities, updated values for the external metrics and current performance output data over a reoccurring reporting time frame. The method further includes utilizing, by each of the entities, the external metrics on the blockchain ledger to perform the at least one local task so as to complete the local task set.

In addition to one or more of the features described above, or as an alternative to any of the foregoing embodiments, utilizing, by at least one of the entities, the blockchain ledger to optimize the at least one local task based on the external metrics reported by one or more remaining entities included in the plurality of entities.

In addition to one or more of the features described above, or as an alternative to any of the foregoing embodiments, the external metrics include at least one of average response times, processing accuracy rates, estimated time of arrival (ETA), throughput volume, error rates, service availability, or completion time for a designated process.

In addition to one or more of the features described above, or as an alternative to any of the foregoing embodiments, determining the at least one external metric comprises performing a perturbation analysis to simulate variations that effect that at least one process of the local task set.

In addition to one or more of the features described above, or as an alternative to any of the foregoing embodiments, continuously reporting the updated values comprises aggregating performance data of at least one of the entities.

In addition to one or more of the features described above, or as an alternative to any of the foregoing embodiments, comprising receiving, by the shared blockchain network, one or more feedback metrics associated with a participating entity. The feedback metrics submitted by other participating entities are based on observed performance.

In addition to one or more of the features described above, or as an alternative to any of the foregoing embodiments, generating, by the shared blockchain network, a composite metric for the participating entity by computing a weighted average of the one or more feedback metrics.

In addition to one or more of the features described above, or as an alternative to any of the foregoing embodiments, reporting the at least one external metric comprises reporting, by each of the entities, the at least one external metric to a blockchain ledger controller operating on the shared blockchain network. The blockchain ledger controller is configured to organize a plurality of reported external metrics based on the at least one external metric reported by each of the entities;

In addition to one or more of the features described above, or as an alternative to any of the foregoing embodiments, reporting the at least one external metric comprises organizing, by the blockchain ledger controller, the at least one external metric reported by each of the entities to generate a plurality of reported external metrics.

In addition to one or more of the features described above, or as an alternative to any of the foregoing embodiments, reporting the at least one external metric comprises reporting the at least one external metric comprises recording, by the block chain ledger controller, the plurality of reported external metrics on the blockchain ledger for shared accessibility by each of the entities participating in the shared blockchain network.

The above features and advantages, and other features and advantages, of the disclosure, are readily apparent from the following detailed description when taken in connection with the accompanying drawings.

According to yet another non-limiting embodiment, a computer program product is provided for performing a multi-participant distributed transaction optimization using a shared blockchain network. The computer program product comprises a set of one or more computer-readable storage media, and program instructions, collectively stored in the set of one or more storage media, for causing a processor set to perform computing operations including generating, by a shared blockchain network, a blockchain ledger accessible by a plurality of entities participating in the shared blockchain network. The plurality of entities including a primary entity configured to complete a transaction, and one or more supporting entities configured to support the primary entity to complete the transaction. The method further includes identifying, by each of the entities, a local task set including at least one local task for which a given entity among the plurality of entities is responsible in order to provide the support. The method further includes determining, by each of the entities, at least one external metric that impacts a performance of the local task set, and determining an organization responsible for providing the at least one external metric. The method further includes reporting, by each of the entities, the at least one external metric and the organization on a blockchain ledger of the shared blockchain network, and continuously reporting on the blockchain ledger, by each of the entities, updated values for the external metrics and current performance output data over a reoccurring reporting time frame. The method further includes utilizing, by each of the entities, the external metrics on the blockchain ledger to perform the at least one local task so as to complete the local task set.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a block diagram illustrating a computing environment, according to one or more embodiments;

FIG. 2 is a flow diagram illustrating a method of performing multi-participant distributed transaction optimization using blockchain according to a non-limiting embodiment of the present disclosure;

FIG. 3 is a diagram depicting an external metrics identification process associated with validating a transaction provided by a primary entity according to a non-limiting embodiment of the present disclosure; and

FIG. 4 depicts a blockchain ledger generated by a shared blockchain network according to a non-limiting embodiment of the present disclosure.

### DETAILED DESCRIPTION

Technically savvy organizations are known to leverage process mining technology in an attempt to understand bottlenecks in their workflows and optimize their processes for maximum return on investment. However, end-to-end business transactions typically involve multiple organizations and one organization has no visibility into the process/data/information when it traverses the boundaries of the organization.

An aspect of the present disclosure is to share abstracted metrics and details among all participants optimizing the end-to-end transaction without compromising confidentiality by applying a novel use of blockchain technology. In a non-limiting embodiment, a method and system for performing a multi-participant distributed transaction optimization using blockchain is provided by sharing processing and workflow information in an aggregated manner as suggested by an interface dictated by the specifics of the end-to-end transaction. This shared aggregated information enables an organization to optimize its processes based not only on its internal data but also based on the aggregated data shared by the other participants in the network. Accordingly, each participant can share authorized transaction details specific to their process to help optimize the complete end to end process. Additionally, the method and system described according to embodiments of the present disclosure guarantee fairness of shared information so that all participating organizations can benefit equally from the shared information. This avoids the risk of potentially unfair results where more powerful organizations can possibly take advantage of the information

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

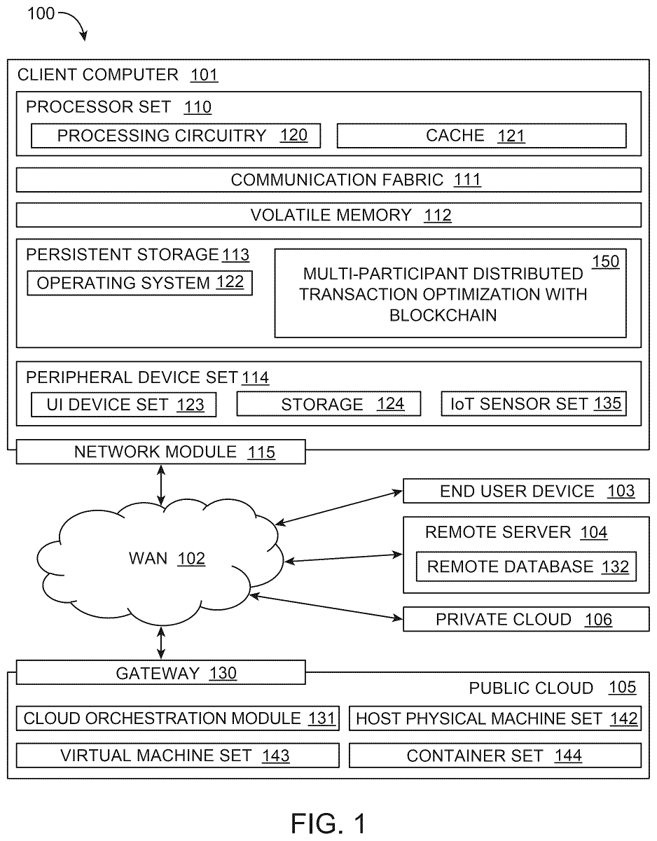

FIG. 1 illustrates a computing environment 100, according to an embodiment. Computing environment 100 contains an example of an environment for the execution of at least some of the computer code to perform a multi-participant distributed transaction optimization using blockchain, as shown at block 150. The computing environment 100 further includes a computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123), storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

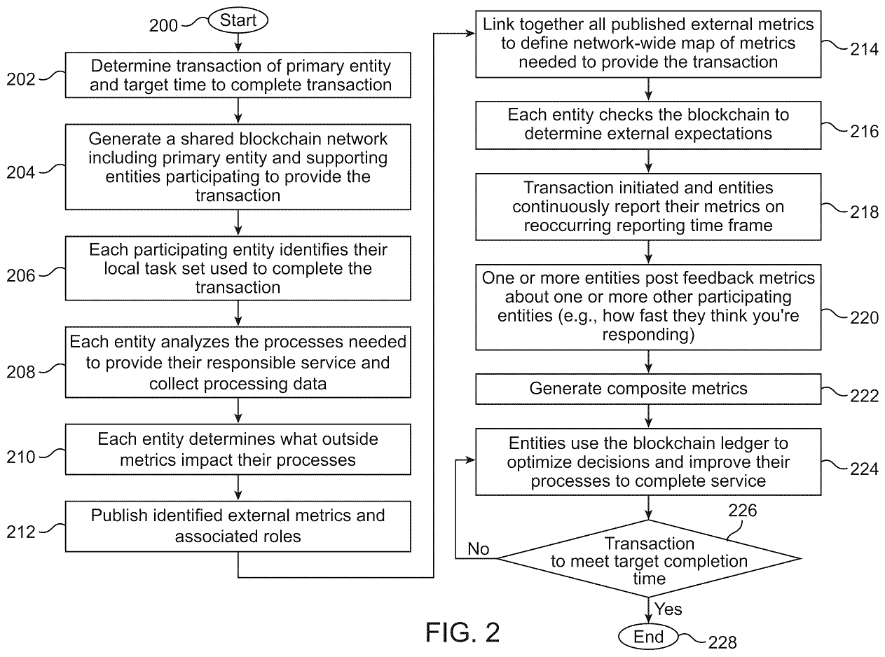

Referring now to FIG. 2, a method of performing a multi-participant distributed transaction optimization with blockchain is illustrated according to a non-limiting embodiment of the present disclosure. The method begins at operation 200 and proceeds to operation 202 to determine a transaction of primary entity and a target time to complete the transaction. A transaction may include a transaction, service or operation provided by a primary entity with the support of one or more supporting entities. The transaction can include, but is not limited to, a purchasing transaction, request for a fabricated component, request to manufacturer a consumer product, request to perform a service, etc.

The target time to complete the transaction can include any range of time set by the primary entity to complete the transaction. For example, a transaction to purchase an automotive vehicle may range from 45 mins to 120 mins, a transaction to fabricate a component of an automotive vehicle may range from 3 weeks to 1 month, and a project to design and manufacture a vehicle may range from 8 months to 1 year.

At operation 204, a shared blockchain network including all participating entities is generated. The participating entities of the shared blockchain network includes the primary entity that will provide the requested transaction, along with one or more supporting entities that will support the primary entity to provide the transaction. In an example where the transaction is the manufacturing of an automotive vehicle, the primary entity be viewed as an automotive vehicle manufacturer that sells the completed automotive vehicle to consumers, while the supporting entities includes various automotive suppliers that supply parts (e.g., brakes, windows, materials, etc.) necessary for the automotive vehicle manufacturer to assemble the vehicle.

At operation 206, each entity participating in the shared blockchain network identifies the services for which they are responsible in order to complete the transaction. According to a non-limiting embodiment, each participating entity analyzes the overall end-to-end transaction to identify its corresponding service responsibilities. This operation involves mapping the internal processes (p) of each given entity (j) to generate a local task set (p_j), which indicates the entity's contribution to the fulfillment of the transaction. The local task set can be defined as: p_j={p_j1, p_j2, . . . , p_jN}). Accordingly, the combination of each entity's local task set (p_j) defines the end-to-end transaction provided by the primary entity and facilitates downstream analysis of performance-affecting metrics as described in greater detail below.

At operation 208, each entity participating in the shared blockchain network analyzes the local tasks needed to provide their responsible service and collects processing data indicating the entity's capability to provide the local task. In a non-limiting embodiment, each participating entity performs an internal process assessment by analyzing its own operational workflows or local tasks. This analysis includes collecting historical or simulated execution data for each process in the entity's identified task set (p_j). Metrics collected may include average and maximum execution times, process trigger frequency, actor involvement, dependency mapping, failure or delay rates, historical data and/or predicted data indicating average processing times, previous and/or expected bottlenecks, processing output trends, etc.

At operation 210, each entity participating in the shared blockchain network determines one or more outside metrics that may impact one or more of the local tasks included in the entity's local task set. In a non-limiting embodiment, a given entity determines external metrics by executing perturbation-based simulations, statistical algorithms and/or machine learning tools to quantify the impact of externally controlled variables. These metrics, which may include execution latency, accuracy, or throughput of partner processes, are flagged for inclusion in a blockchain ledger and can be utilized for analysis by the other entities participating in in the shared blockchain network. For example, the primary entity and one or more supporting entities can utilize the blockchain ledger to perform an external metrics identification process, which is described in greater detail below.

At operation 212, each entity participating in the shared blockchain network publishes or reports the identified external metrics or raw materials, and associated roles on the blockchain ledger. For example, each participating entity registers its identified external metrics of interest and/or raw materials on the blockchain ledger, along with the designated role or organization responsible to report those external metrics and/or provide the raw materials. For example, a designated role or organization may include a payment processor that designates a credit bureau as the responsible organization to report the average credit check response time metric. In another example, a windshield supplier may designate a glass processor as the responsible organization to report the raw materials lead time or glass production yield rate metric. Accordingly, an expectations framework is generated whereby performance influences are transparently published and linked to accountable roles. These entries are made available across the blockchain network via the blockchain ledger, enabling the other entities participating in the shared blockchain network to query and align their reporting responsibilities accordingly.

Turning to operation 214, all published external metrics are combined or linked together to define network-wide map of important metrics need to provide the transaction. For example, after each participating entity has reported the external metrics relevant to its internal processes, along with the roles responsible for those metrics, the blockchain ledger is updated at operation 214 to include all such entries across the network. Accordingly, the ledger now contains a comprehensive record of the external metrics that are important to each entity, and identifies which roles or organizations are expected to report those external metrics and/or raw materials. This shared information forms a network-wide reference that participating entities can use to understand performance expectations and dependencies across the end-to-end transaction.

At operation 216, the entities participating in the shared blockchain network analyzes the blockchain ledger to determine the external expectations reported by each participating entity. In a non-limiting embodiment, each participating entity queries the blockchain ledger to identify which external metrics it is expected to report, based on prior entries made by other participants. These entries specify the metrics that impact the other entities' processes and designate the roles or other entities responsible for providing the impactive metrics. Accordingly, each entity can clearly understand its reporting obligations within the shared blockchain network.

At operation 218, the end-to-end transaction is initiated and the entities participating in the shared blockchain network continuously report their metrics on reoccurring reporting time frame. In a non-limiting embodiment, each participating entity publishes updated values for the external metrics it is responsible for, as identified by other network entities. The updated values refer to a current performance measurements generated by a participating entity based on recent operational data collected over a defined reporting time frame. In a non-limiting embodiment, the updated values can include, but are not limited to, average response times, processing accuracy rates, estimated time of arrival (ETA), throughput volume, error rates, service availability, or completion time for a designated process. These updates are aggregated over defined time intervals, e.g., a reoccurring reporting time frame (e.g., hourly, daily, weekly, etc.), and recorded on the blockchain ledger. In this manner the shared blockchain network provides continuous, verifiable visibility into key performance indicators relevant to optimizing the end-to-end transaction provided by the primary entity.

After the end-to-end transaction is initiated, the method proceeds to operation 220 during which one or more of the entities participating in the shared blockchain network report feedback metrics about one or more of the other participating entities. In a non-limiting embodiment, each participating entity may receive feedback (i.e., feedback metrics) from one or more other entities based on observed performance during direct interactions. These feedback metrics are a result from the exchange between an entity providing its local service (e.g. a servicing entity) and one or more entities receiving the service (e.g., a receiving service). The feedback metrics are then reported and recorded on the blockchain ledger, thereby indicating real-world experiences and service quality ratings such as, for example, response time, delivery accuracy, and/or product quality. The feedback metrics for a given entity can be used to generate a reputation score.

Turning to operation 222, a composite metric is generated based on the reported feedback metrics. In a non-limiting embodiment, the shared blockchain network aggregates all reported metric values, including self-reported and peer-submitted experiences, into a composite metric using a weighted averaging process based on the reputation score of the corresponding entity. The resulting composite metric is then recorded on the blockchain ledger and made accessible to all participating entities. In this manner, performance insights used for optimization are derived from verified, network-endorsed values rather than single-source reports.

At operation 224, entities participating in the shared blockchain utilize the current up-to-date blockchain ledger to optimize decisions and improve their processes to complete service. In a non-limiting embodiment, each participating entity can utilize the most up-to-date aggregated and verified metrics recorded on the blockchain ledger to make informed business decisions and optimize its internal processes.

At operation 226, one or more entities participating in the shared blockchain network can determine whether the end-to-end transaction is trending to meet the target time (e.g., determined at operation 202). When a given entity determines that the target timing may not be met, the entity can re-analyze the blockchain ledger re-evaluate resource allocation and/or selection of the role or organization originally designated to provide their external metrics and/or raw materials. For example, the end-to-end transaction can be determined to be behind schedule when a given entity reports a bottleneck and/or one supporting entity reports on the ledger than another supporting ledger has missed a target date. When, however, the timing of the end-to-end transaction is determined to be on target, the entities can maintain their current operations and the method ends at operation 228. Accordingly, the current up-to-date blockchain ledger enables participants to evaluate external service quality, anticipate process bottlenecks, and adapt resource allocation or partner selection strategies accordingly. As a result, performance improvements for a given entity are driven not only by internal insights but also by transparent, network-wide insights and transparent operational data.

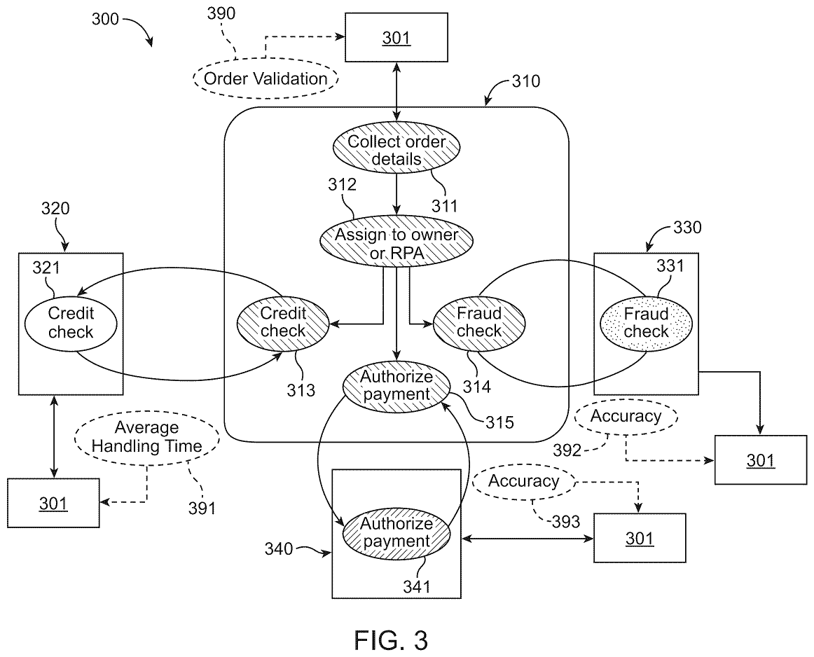

With reference now to FIG. 3, a diagram depicting an external metrics identification process associated with validating a transaction facilitated by a shared blockchain network according to a non-limiting embodiment of the present disclosure. The shared blockchain network 300 includes a blockchain ledger controller 301, a primary entity 310, a first supporting entity 320, a second supporting entity 330, and a third supporting entity 340. Each of the primary entity 310, the first supporting entity 320, the second supporting entity 330, and the third supporting entity 340 can include a local controller or local client computer 101 (see FIG. 1) that is in signal communication with the blockchain ledger controller 301. In this manner, bi-directional data exchange and accessibility is facilitated among each of the first supporting entity 320, the second supporting entity 330, and the third supporting entity 340 which are in signal communication with the blockchain ledger controller 301.

The blockchain ledger controller 301 includes memory and a processor configured to execute algorithms and computer-readable program instructions stored in the memory. In a non-limiting embodiment, the blockchain ledger controller 301 is implemented as a client computer 101 that performs a multi-participant distributed transaction optimization using blockchain (see FIG. 1). In the example shown in FIG. 3, the multi-participant distributed transaction optimization includes determining an end-to-end task 390 (e.g., order validation) requested by a primary entity 310, organizing external metrics 391-393 reported by the first, second and third entities 320, 330 and 340, and generating a blockchain ledger based at least in part on the reported external metrics 391-393. The blockchain ledger is then made accessible by the primary entity 310 and first, second and third supporting entities 320, 330, 340. In a non-limiting embodiment, the blockchain ledger controller 301 receives information identifying the end-to-end task 390 to be performed by the primary entity 310, and at least one external metric reported by each of the first, second, and third supporting entities 320, 330, 340. Accordingly, the blockchain ledger controller 301 organizes the external metrics 391-393 reported by each of the supporting entities 320, 330, 340 to generate a plurality of reported external metrics, and records the reported external metrics on the blockchain ledger. The blockchain ledger with the recorded reported external metrics is then made accessible to each of the primary entity 310, along with the first, second and third supporting entities 320, 330, 340 participating in the shared blockchain network 300.

In a non-limiting embodiment, the primary entity 310 is an automotive sales company seeking to complete an end-to-end transaction such as, for example, to validate a customer order 390 for an automobile. The first supporting entity 320 is a creditor organization responsible to perform credit checks 321 and validate the financial credit of customers. The second supporting entity 330 is a fraud prevention organization responsible for performing fraud checks 331 to prevent fraudulent activities performed by the customer. The third supporting entity 340 is a banking institution responsible for effecting payment 341 between the customer and the automotive sales company.

To identify relevant external metrics that affect its order validation process 390, the primary entity 310 begins by analyzing its internal tasks necessary for processing and validating a customer order. This internal process typically includes steps such as receiving and collecting details associated with an order 311, assigning the order to an individual authorized to execute the related tasks such as, for example, an employee of Robotic Process Automation (RPA) 312, requesting credit validation 313, requesting a fraud check 314, and facilitating payment authorization 315. While these local tasks occur within the operational scope of the primary entity 310, the success and timeliness of the order validation 390 necessary to validate a customer order and complete the sale of the automotive vehicle to the customer depend on the external service metrics 391-393 performed by the supporting entities 320, 330 and 340.

The primary entity 310 conducts an external metrics analysis to determine which external metrics (e.g., average handling time to perform a credit check 391, accuracy of the fraud check results 392, and accuracy of the customer financing and payment 393) most significantly influence its ability to accurately and successfully validate a customer order and complete the sale of the automotive vehicle to the customer. In a non-limiting embodiment, the primary entity 310 performs the external metrics analysis using a combination of historical performance data and simulation-based modeling. For example, the primary entity 310 analyzes the average response time of credit validation services 391, the accuracy of fraud detection results 392, and the speed and accuracy of payment authorizations 393 to evaluate how each of these external metrics affect the local tasks 311-315. This approach can be referred to as a “perturbation analysis” and allows the primary entity 310 to assess the impact of a range of conditions on its own process performance.

In addition to simulation, the primary entity 310 can apply machine learning techniques, such as feature importance ranking, to identify which external variables are most predictive of downstream outcomes, such as order approval delay or customer abandonment. By correlating fluctuations in internal performance with external service variability, the primary entity 310 isolates the external metrics that have the greatest operational influence.

Through this process, the primary entity 310 (e.g., the automotive sales company) identifies at least three external metrics of significance. First, the primary entity 310 identifies a credit response time metric associated with the first supporting entity 320 (e.g., the creditor organization). This metric represents the average time taken by the creditor organization 320 to return a credit evaluation result. Second, the primary entity 310 identifies a fraud score accuracy metric associated with the second supporting entity 330 (e.g., the fraud prevention organization). This metric reflects the reliability of the fraud detection organization 330 to accurately detect fraudulent activity, which may influence approval thresholds or trigger manual reviews. Third, the primary entity 310 identifies a payment authorization latency metric associated with the third supporting entity 340 (e.g., the banking institution). This metric captures the average time required by the banking institution 340 to authorize and finalize the customer's payment transaction.

By identifying these metrics, the primary entity 310 establishes a clear understanding of which external services directly affect its ability to validate customer orders efficiently and reliably. The primary entity 310 uses these findings to prepare structured metric entries for submission to the shared blockchain ledger.

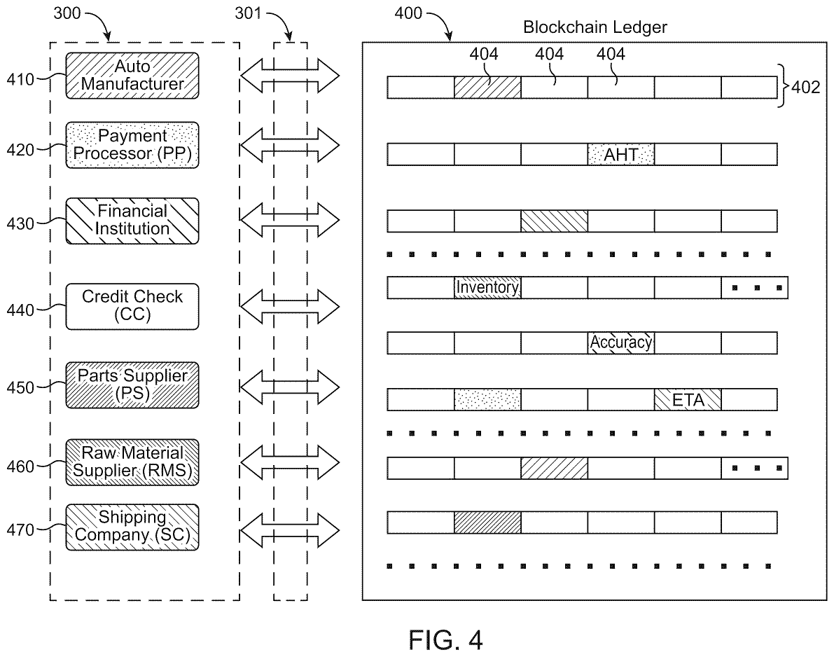

Turning now to FIG. 4, a blockchain ledger 400 generated by a shared blockchain network is illustrated according to a non-limiting embodiment of the present disclosure. As described herein, the blockchain ledger 400 generated by the shared blockchain network 300 can serve as a decentralized, verifiable system of record that captures ongoing performance metrics across all participating entities in the network. It enables each entity to both publish and consume trustworthy, multi-source data for the purpose of optimizing its role within a larger collaborative transaction.

With continued reference to FIG. 4, the blockchain ledger 400 is generated by a blockchain ledger controller 301 operating on the shared blockchain network 300. The shared blockchain network consists of various participating entities including a primary entity 410 and supporting entities 420, 430, 440, 450, 460, and 470 (collectively referred to as 410-470), all of which are involved in fulfilling an end-to-end business transaction such as, for example, processing a customer order for an automobile. In the example shown in FIG. 4, the participating entities include an auto manufacturer 410, a payment processor (PP) 420, a financial institution 430, a credit check organization (CC) 440, a parts supplier (PS) 450, a raw material supplier (RMS) 460, and a shipping company (SC) 470. Each entity 410-470 plays a defined role in completing the overall transaction and maintains communication with the blockchain ledger 400.

Each row 402 of the blockchain ledger 400 corresponds to a specific entity 410-470 and contains a timeline of data blocks 404 representing metric reports submitted by a given entity 410-470. These metric entries are aligned to discrete time intervals and illustrate the periodic reporting of operational performance data. The data blocks include self-reported metrics (e.g., average handling time, delivery estimates) from the entities 410-470, as well as observed feedback from the entities 410-470. In some cases, the blockchain ledger 400 may also display aggregated or composite metrics, which are derived through a reputation-weighted averaging process.

In the example shown in FIG. 4, the payment processor 420 reports a metric labeled “AHT,” which refers to average handling time for transaction approvals. This metric, which may be originally identified by the auto manufacturer 410 as externally impactful, is registered in the blockchain ledger 400 and updated at recurring intervals. The financial institution 430 submits performance data related to payment authorization, while the credit check organization 440 contributes a metric labeled “Inventory,” which may reflect its queue of pending credit checks or service load capacity. The parts supplier 450 provides two key external metrics: an operational processing time and an estimated time of arrival (ETA), both of which are critical for the auto manufacturer to plan production schedules and delivery timelines.

The raw material supplier 460 contributes aggregated availability or forecast data, enabling the parts supplier 450 to optimize upstream component planning. Similarly, the shipping company 470 submits performance data, which may include delivery latency, fulfillment confirmation, and/or logistics accuracy. As described herein, all the participating entities 410-470 can access the blockchain ledger 400 to determine what metrics they are expected to report, and then use the reported values from one or more of the other entities 410-470 to adjust their internal workflows. In some cases, gaps or intentionally anonymized entries may reflect decisions by a given entity 410-470 to withhold sensitive information or share only abstracted summaries.

As described herein, various non-limiting embodiments of the present disclosure facilitate multi-participant distributed transaction optimization using a novel blockchain approach. The optimization includes method to identify metrics of importance per role and leverages blockchain technology to implement a fair and trusted method for communicating such metrics. The invention applies a novel approach using blockchain technology to guarantee trust and fairness and avoid one of the participants being at an advantage compared to others.

While the foregoing is directed to embodiments of the present disclosure, other and further embodiments of the present disclosure may be devised without departing from the basic scope thereof, and the scope thereof is determined by the claims that follow.

1. A computer-implemented method for performing a multi-participant distributed transaction optimization using a shared blockchain network, the method comprising:
generating, by a shared blockchain network, a blockchain ledger accessible by a plurality of entities participating in the shared blockchain network, the plurality of entities including a primary entity configured to complete a transaction, and one or more supporting entities configured to support the primary entity to complete the transaction;
identifying, by each of the plurality of entities, a local task set including at least one local task for which a given entity among the plurality of entities is responsible in order to provide the support;
determining, by each of the plurality of entities, at least one external metric that impacts a performance of the local task set, and determining an organization responsible for providing the at least one external metric;
reporting, by each of the plurality of entities, the at least one external metric and the organization on a blockchain ledger of the shared blockchain network;
continuously reporting on the blockchain ledger, by each of the plurality of entities, updated values for the external metrics and current performance output data over a reoccurring reporting time frame; and
utilizing, by each of the plurality of entities, the external metrics on the blockchain ledger to perform the at least one local task so as to complete the local task set,
wherein determining the at least one external metric comprises performing a perturbation analysis to simulate variations that effect the at least one process of the local task set, wherein the at least one external metric is flagged for inclusion in the blockchain ledger based on the perturbation analysis, and wherein the blockchain ledger is updated to include the flagged at least one external metric.

2. The method of claim 1, further comprising utilizing, by at least one of the plurality of entities, the blockchain ledger to optimize the at least one local task based on the external metrics reported by one or more remaining entities included in the plurality of entities.

3. The method of claim 2, wherein the external metrics include at least one of average response times, processing accuracy rates, estimated time of arrival (ETA), throughput volume, error rates, service availability, or completion time for a designated process.

4. (canceled)

5. The method of claim 1, wherein continuously reporting the updated values comprises aggregating performance data of at least one of the plurality of entities.

6. The method of claim 1, further comprising receiving, by the shared blockchain network, one or more feedback metrics associated with a participating entity, the feedback metrics submitted by other participating entities based on observed performance.

7. The method of claim 6, further comprising generating, by the shared blockchain network, a composite metric for the participating entity by computing a weighted average of the one or more feedback metrics.

8. The method of claim 1, wherein reporting the at least one external metric comprises:
reporting, by each of the plurality of entities, the at least one external metric to a blockchain ledger controller operating on the shared blockchain network, the blockchain ledger controller configured to organize a plurality of reported external metrics based on the at least one external metric reported by each of the plurality of entities;
organizing, by the blockchain ledger controller, the at least one external metric reported by each of the plurality of entities to generate a plurality of reported external metrics; and
recording, by the block chain ledger controller, the plurality of reported external metrics on the blockchain ledger for shared accessibility by each of the plurality of entities participating in the shared blockchain network.

9. A shared blockchain network comprising:
a primary entity configured to complete an end-to-end transaction;
a plurality of supporting entities configured to perform a local task set which supports the primary entity to complete the transaction, the local task set including at least one local task; and
a blockchain ledger controller configured to generate a blockchain ledger accessible by the primary entity and the plurality of supporting entities,
wherein the blockchain ledger controller receives a plurality of external metrics from the primary entity and the plurality of the supporting entities and records the external metrics to blockchain ledger,
wherein the primary entity and the plurality of supporting entities utilize the blockchain ledger to perform the at least one local task so as to complete the local task set, and
wherein the blockchain ledge controller:
determines the at least one external metric comprises by performing a perturbation analysis to simulate variations that effect the at least one process of the local task set;
flags the at least one external metric for inclusion in the blockchain ledger based on the perturbation analysis; and
updates the blockchain ledger to include the flagged at least one external metric.

10. The shared blockchain network of claim 9, wherein the blockchain ledger controller continuously receives, by each of the supporting entities, updated values for the external metrics and current performance output data over a reoccurring reporting time frame.

11. The shared blockchain network of claim 10, wherein the primary entity and the plurality of supporting entities each determine the local task set necessary to provide the support; and
wherein each of the supporting entities identifies at least one external metric among the plurality of external metrics, the at least one external metric determined to impact a performance of the local task set.

12. The shared blockchain network of claim 11, wherein at least one of supporting entities utilizes the blockchain ledger to optimize the at least one local task based on the recorded external metrics reported by one or more remaining supporting entities included in the plurality of supporting entities.

13. The shared blockchain network of claim 9, wherein the plurality of external metrics include at least one of average response times, processing accuracy rates, estimated time of arrival (ETA), throughput volume, error rates, service availability, or completion time for a designated process.

14. (canceled)

15. The shared blockchain network of claim 9, wherein the updated values are continuously reported in response to aggregating performance data of at least one of the supporting entities.

16. The shared blockchain network of claim 9, wherein the blockchain ledger controller receives one or more feedback metrics based on observed performances between the primary entity and the plurality of supporting entities, and updates the blockchain ledger based on the one or more feedback metrics.

17. The shared blockchain network of claim 16, wherein the blockchain ledger controller generates a composite metric for the participating entity by computing a weighted average of the one or more feedback metrics.

18. A computer program product for performing a multi-participant distributed transaction optimization using a shared blockchain network, the computer program product comprising:
a set of one or more computer-readable storage media;
program instructions, collectively stored in the set of one or more storage media, for causing a processor set to perform the following computer operations:
generating, by a shared blockchain network, a blockchain ledger accessible by a plurality of entities participating in the shared blockchain network, the plurality of entities including a primary entity configured to complete a transaction, and one or more supporting entities configured to support the primary entity to complete the transaction;
identifying, by each of the entities, a local task set including at least one local task for which a given entity among the plurality of entities is responsible in order to provide the support;
determining, by each of the entities, at least one external metric that impacts a performance of the local task set, and determining an organization responsible for providing the at least one external metric;
reporting, by each of the entities, the at least one external metric and the organization on a blockchain ledger of the shared blockchain network;
continuously reporting on the blockchain ledger, by each of the entities, updated values for the external metrics and current performance output data over a reoccurring reporting time frame; and
utilizing, by each of the entities, the external metrics on the blockchain ledger to perform the at least one local task so as to complete the local task set,
wherein determining the at least one external metric comprises performing a perturbation analysis to simulate variations that effect the at least one process of the local task set, wherein the at least one external metric is flagged for inclusion in the blockchain ledger based on the perturbation analysis, and wherein the blockchain ledger is updated to include the flagged at least one external metric.

19. The computer program product of claim 18, further comprising utilizing, by at least one of the entities, the blockchain ledger to optimize the at least one local task based on the external metrics reported by one or more remaining entities included in the plurality of entities.

20. The computer program product of claim 19, wherein the external metrics include at least one of average response times, processing accuracy rates, estimated time of arrival (ETA), throughput volume, error rates, service availability, or completion time for a designated process.
